(19) United States
(12) Patent Application Publication
(10) Pub. No.: US 2006/0263558 A1
(43) Pub. Date: Nov. 23, 2006

(54) Continuous intermediate prime label pressure sensitive assembly

(75) Inventor: Jesse D. Crum, Fort Scott, KS (US)

Correspondence Address: WARD/KRAFT, INC., 2401 COOPER STREET, P. O. BOX 938, FT. SCOTT, KS, 66701, US

(73) Assignee: Ward/Kraft

(21) Appl. No.: 11/135,131

(22) Filed: May 23, 2005

(51) Int. Cl. B32B 33/00

(52) U.S. Cl. 428/40.1; 428/42.3

(57) ABSTRACT

The present invention is in the field of identifiers such as tags and labels, which may be used in advertising, marketing, communications or for designating a source of a particular product or service and relates to a method of manufacturing prime label intermediates in an unique continuous web format. The subject of this application specifically includes pressure sensitive laminates that are produced in a sheet to roll type of format and provided in one or more intermediate configurations to an end user. A series of sheets are pre-printed, then slit or cut to size to create individual ribbons or label segments, with each segment having prime label areas. The prime label segments are then applied to a continuously advancing web so as to create a web having a series of discontinuous label segments disposed thereon. More particularly, the pressure sensitive laminates of the instant application can be used to create individual, prime labels having a high or photo quality resolution level, of more than about 150 lines per inch and preferably about about 300 lines per inch.

### CROSS-REFERENCES TO RELATED APPLICATIONS

None.

### FIELD OF THE INVENTION

The present invention is in the field of manufacturing intermediate web assemblies to produce identifiers such as tags and labels that may be used in advertising, marketing, communications or for designating a source of a particular product or service. The subject of this application specifically includes a method of manufacturing prime labels from an intermediate pressure sensitive web construction and the article produced from that manufacture. The labels of the present invention are produced in part, initially from a pre-imaged or printed sheet and then converted or merged to a roll type of format and provided in one or more intermediate configurations to an end user. The sheets are printed with high quality graphics or images which are then slit or cut to size to form ribbons or label segments for the prime label application and then are converted to or merged with a continuously advancing web to create a continuous roll format. More particularly, the pressure sensitive laminates of the instant application can be used to create individual, prime labels having a high or photo quality resolution level that is about 300 lines per inch or approximately 2500 to 3500 dots per inch.

### BACKGROUND OF THE INVENTION

Today, there are wide varieties of product offerings available that serve multiple purposes and functions, including product offerings that are used in fulfilling needs in the prime label market. Conventional processes that are used today in creating prime labels are typically based on a continuous web technology using flexographic presses. The process includes the feeding of a continuous web of material, such as a preformed web of pressure sensitive laminate which normally consists of a top ply having a layer of adhesive on its underside that is covered by a release liner to form the laminate assembly through the press. The web is then processed through a press, typically a flexographic press, and an image is applied to the web by various stations. The web may then be collected, die-cut and the individual labels removed and applied.

Flexography is commonly used today for the printing of decorative items including the rendering of packaging and employs a series of plates and one or more stations, containing inks, to apply colored images to the web as the web traverses the press. Through improvements in ink qualities and other modifications and enhancements in the technology, the image quality in flexographic presses and resulting products has improved to about 150 lines per inch.

For a point of reference, typically, screens that have rulings of between 60 to 100 lines per inch are normally used to make halftone printed images for newspapers. Screens with about 120 to 150 lines per inch are commonly used today to produce images for magazines and commercial printing. Such screens are regularly produced by electronic dot generation.

Electronic dot generation is normally performed by computers that use unique screening algorithms in cooperation with electronic scanners and image setters to produce halftone images that are to be subsequently used to render an image. The pixels of digitized images are first assembled into dots that are then used to form shapes, sizes, rulings, etc. which create the ultimate image produced on the substrate.

While flexographic technology or flexography is desirable for use in such printing due to the economies that can be achieved when compared with other types of printing processes, such as lithography, there are a number of drawbacks in utilizing this process for certain applications. Initially, the quality is limited, despite improvements in the technology to about 150 lines per inch. This can make some complicated graphics appear “grainy” or other images, such as those that use flesh tones or deep or rich colors, look faded or “washed out”. The effects of this level of image resolution can detract from the product appearance which may diminish the value of the technology and the products produced particularly for the prime label market. With increasing sophistication of consumers, as well as technology and expectations from each, such effects may be undesirable to potential end users.

Flexography also suffers from other drawbacks, such as the time involved in preparing a job to run or “make ready” as it may otherwise be known. That is, the steps that are used to prepare the flexography equipment for running a particular job or order. This make ready includes such activity as the preparation of multiple plates to produce the image at each station, mixing inks, calibration and alignment of the images between stations and the like. Operation of the flexography presses may also include multiple operators which can add to manufacturing costs. In addition, waste can also be a problem with such conventional printing technologies in that a number of feet, yards or meters of web material must be processed through the press in order to have the colors reach a predetermined threshold and to ensure appropriate registry of the stations as they are printing the images on the web. The amount of material wasted can be several times the length of the press or up to several hundred feet of material. The use of such volumes of materials obviously increases the cost of the operation. Thus, due to the make ready and waste factors, the production of a products, such as prime labels, using flexography may then be limited to serving only certain market segments, namely large market segments. Markets that are applicable for this technology segment are generally believed to be those orders for large quantities of several hundred thousand or millions of pieces, which potentially leaves the smaller label market, e.g. 100 to 1,000,000 labels, unfulfilled or at least not adequately served by currently available technologies due to cost and materials thresholds.

Another drawback believed to be associated with flexographic technologies is that the technology cannot provide any variability in the product, including such basic functionality as sequential numbering, addressing or adding promotional text in connection with a seasonal advertisement or other offering without the addition of further processing stations. If such features are required by an end user or customer, such as with product date or coding, this function generally cannot be performed by flexographic presses without the inclusion of additional stations and instead typically must occur through an off line operation, such as ink jetting, often after the label has been applied to the container or carton. Alternatively, the ink jetting may be performed directly on the container as part of a separate operation.

Flexographic presses normally have a number of pre-determined stations, for example a four color press may have only four stations that can be used to treat or process the web. Thus, if other stations are to be added, such as a numbering head, the manufacturer likely then has to reduce the number of colors that can be added to the web as one station has been surrendered for the numbering head.

Flexographic technology also limits the ability to add personalization to products produced on such presses. This may be particularly desirable in certain market segments such prime label products on consumer package goods (“CPG”) which may further enhance the product or service offering by making the product more attractive to prospective purchasers, thereby increasing the appeal to the consumer of the product or service.

Identifiers such as labels or tags may also be readily rendered using desktop equipment. While the resolution may be slightly improved when compared with conventional flexographic technology, speeds of application are significantly reduced as the images are processed in a sheet wise fashion on desktop equipment resulting in only a few sheets per minute as opposed to hundreds of feet per minute that are capable of being processed by flexographic equipment. That is, the desktop unit may only handle and print one sheet at a time before the next sheet is advanced for printing or imaging when compared with a conventional web fed process. Thus, in using such a desktop process one may only be able to render a handful of sheets per minute as opposed to a flexography operation that may process several hundred feet per minute. Use of desktop processes is thus not likely efficient in trying to generate hundreds and certainly not thousands of labels, but may be useful in creating a few dozen labels for very small applications such as a small home or small office environment.

What is needed therefore is a process by which high quality graphics for prime label applications, in excess of about 150 lines per inch, can be produced in an efficient and cost effective manner, such as in a continuous process operating at greater than fifty feet per minute. Moreover, a process which can add substantial variability to the product as well as other features, such as embossments, over laminates, variable printing or imaging and the like, would greatly expand the penetration of this form of business communication in the marketplace. The present invention seeks to provide a prime label intermediate having a quality of about 150 or more lines per inch and preferably more than 300 lines per inch, which is approximately equal to about 2500 to 3500 dots per inch (“DPI”) in order to create a high quality image that is intended to be aesthetically appealing to the consumer.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Surprisingly, it has been discovered that there is no readily available process or system by which a manufacturer can create high quality prime labels having significantly improved graphic resolution that is greater than about 150 lines per inch, preferably greater than about 200 lines per inch and still more preferably about 300 lines per inch, in an efficient and cost effective manner. The development of the present system, process and the creation of the unique intermediate web assembly described in this invention permit the servicing of a particular niche market segment for prime labels, that of approximately 1000 to 1,000,000 prime labels. While the foregoing market size or segment is a target area of the present invention, it should be appreciated that the invention may be practiced and used to fulfill larger order quantities, such as those of a million labels or more.

The pressure sensitive intermediate of the present invention is created through a unique sheet to roll process which provides savings when compared with conventional flexography process, specifically through reduced make ready time and generation of waste material and yields a higher image resolution product. The present invention uses previously prepared individually created sheets, or segments, that have imaging or printing already applied to the sheets, e.g. graphical depictions, before the sheets are provided to the manufacturing press. The sheets, ribbons or segments may be applied to the web in a number of patterns, including substantially edge-to-edge configuration, with a slight overlap or alternatively, provided in regularly occurring increments depending on the needs of the particular application to be serviced. In addition, the product produced in connection with the present process described in the instant application is also not limited in functionality as a number of materials, operations and options may be used in creating a relatively dynamic product. Such additional processes may include variable printing, embossments, coatings, over laminates and the like.

By preparing the intermediate prime label assembly in the manner described herein, the intermediate web can be processed continuously at speeds of greater than 50 feet per minute, preferably between 75-150 feet per minute and still more preferably at speeds of about 200 feet per minute or greater.

In one exemplary embodiment of the present invention, a pressure sensitive prime label intermediate web is described and includes a continuous base web that has first and second faces and first and second longitudinally extending sides. The web is intended to be continuously advanced in a machine direction, which corresponds to the direction of processing stations of the web. A pattern of adhesive is applied to one of the first and second faces of the continuous base web, between the first and second longitudinally extending sides in the machine direction. The adhesive will preferably be a permanent type pressure sensitive adhesive, although other adhesive types are of course suitable for use with this invention.

Continuing with a description of the presently described embodiment is a series of individual previously prepared sheets, each having imaging, printing and/or graphical depictions. Each of the sheets has first and second faces, first and second ends and first and second sides. As mentioned already, the first face of each of the sheets has already been provided with printing or imaging with creating various graphical depictions with each depiction having a resolution of more than about 150 lines per inch. The second face of each of the sheets is placed in contact with the pattern of adhesive such that the sheets are adhered to the face of the continuous base web. The sheet may have an image printed on one side, top or bottom or on both sides. Where an image is applied only to one side, the image may be facing upwardly or be in contact with the web. In either event, the image will ultimately be visible when placed on the receptacle or container (visible through a glass bottle if the image in contact with the web). The pre-imaged sheets are disposed substantially in an end-to-end configuration and are not themselves connected to one another to create an intermediate prime label web assembly having a series of discontinuous prime label segments or ribbons that are free of connection to one another.

In a further exemplary embodiment of the present invention, a prime label intermediate web assembly is described and includes a continuous carrier web that has first and second faces, first and second longitudinally extending sides and a release coating applied between the first and second longitudinally extending sides and on the first face. An adhesive applied to the carrier web over the release coating so that the adhesive will “release” to the back of label segments when they are subsequently removed from the carrier web.

Continuing with a description of the presently described embodiment, a sheet of material that has a number of pre-printed prime label areas is divided in to individual segments with each of the segments having a dimension that is less than the sheet. Each segment has at least one prime label area (areas of the segments that will be removed and will become the prime label that is applied to a container), with each of the prime label areas having a graphical depiction provided on at least one face.

Each of the segments in the presently described embodiment is applied in a pattern to the carrier web over the adhesive substantially in an edge to edge configuration such that the face with said graphical depiction is visible upon application to a container.

In a still further exemplary embodiment of the present invention, a method of creating a prime label intermediate pressure sensitive web is described and includes the steps of initially providing a continuous web of material that has first and second faces and first and second longitudinally extending sides. The continuous web is advanced in a machine direction to a first station with a minimum machine speed of about 50 feet per minute. Next, a pattern of adhesive is applied in the machine direction to the first face of the continuous web.

A series of previously prepared prime label segments are supplied to an inserter that is used to individually place each of the segments serially and substantially continuously on the web and over the pattern of adhesive in the machine direction such that each of the prime label segments are positioned in a substantial edge-to-edge configuration.

In the presently described embodiment, the continuous web with the prime label segments disposed thereon is advanced in a machine direction to a collection point to create a continuous, intermittently laminated web that has a series of repeating prime label segments that are free of one another. The term “intermittently laminated” refers to the connection of the sheets, which are separate and distinct from one another, to the web, as each of the sheets is individually laminated to the web by contact of the sheet with the web.

In a still further exemplary embodiment of the present invention, a pressure sensitive prime label intermediate assembly for use in prime labeling of a package or container is described and includes a package that has at least one surface which is suitable for receiving a label. A prime label is applied to the package on the exposed surface. The prime label is produced from an intermediate web assembly that includes a continuous carrier web which has first and second faces and first and second longitudinally extending sides.

A pattern of adhesive is applied to the first face of the continuous carrier web and between the first and second longitudinally extending sides. A series of individual pre-imaged prime label segments each having first and second faces, first and second ends and first and second sides. The first face of each of the prime label segments has at least graphical depictions with each depiction having a resolution of more than about 150 lines per inch. The second face of each of the segments is placed in contact with the pattern of adhesive such that the segments are adhered to the first face of the continuous carrier web. The pre-imaged segments are disposed substantially in an end-to-end configuration and are not connected to one another to create an intermediate prime label web assembly having a series of discontinuous prime label segments. The prime label segments may be provided with identical graphical depictions or the depiction may vary from label segment to label segment.

The production of the prime label intermediate web assembly prepared in accordance with the present invention creates an intermediate web assembly that has intermittent laminations. That is, portions of the prime label segments are adhered to the web and smaller portions, such as the edges, may be free of adherence due to a slight overlap between successive prime labels segments disposed on the web. The overlap is preferably less than an inch, more preferably less than one half of one inch and still more preferably less than about 1/32″ and still yet more preferably less than about 1/64′. The overlap may be created to facilitate the placing of sheets on the web and accommodates slight changes in timing that may occur due to web or placer mechanism speed. It should be understood that it may not be necessary to create an overlap and the sheets may be laid edge to edge or alternatively the sheets may be spaced from one another along the web. In this latter configuration, the adhesive, if exposed may be deadened by application of radiation, over coatings or the like.

The prime label segments or sheets are pre-imaged or printed prior to being applied to the carrier web. In this manner, a number of permutations can be made to the prime label and thus the labels are not limited by equipment constraints as may be found in connection with other equipment used in preparing prime labels. The prime label segments or sheets can be provided in a number of shapes, and may be produced with coatings, numbering, embossments and pseudo embossments, as described in commonly assigned, co-pending application Ser. No. 10/980,347 filed Nov. 3, 2004 the disclosure of which including that found in the claims is incorporated herein by reference.

In addition to various surface treatments (e.g. printing, coating, etc.) that may be applied to the prime label sheets or segment, the prime labels may be provided in a number of shaped configurations, (e.g. quadrate, non-quadrate, geometric, animate, inanimate, alpha, numeric and combinations thereof). The prime label segments may also be imaged in line with variable information, such as numbering, personalization, coding and the like.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a top or surface view of the prime label intermediate web assembly of the present invention showing a series of label segments or ribbons with graphical depictions that vary from one segment to the next;

FIG. 2 illustrates a side elevation of the present invention depicted in FIG. 1 showing the prime label segments substantially in an edge-to-edge configuration;

FIG. 3 demonstrates an exemplary use of a prime label prepared from the intermediate assembly described in the present invention and shown in connection with a consumer package good;

FIG. 4 shows a sheet of stock material that has been previously prepared having a series of individual prime label intermediates on the sheet of material as used in the present invention;

FIG. 5 provides a block diagram setting forth exemplary steps that may be used in carrying out the presently described invention to create the prime label intermediates;

FIG. 6 depicts a schematic of the apparatus that is used to carry out the invention; and

FIG. 7 illustrates the continuous web assembly of the present invention having a number of individual prime label intermediates showing one embodiment with the matrix stripped away and connected to one another by a supporting strip or string.

### DETAILED DESCRIPTION OF THE INVENTION

The present invention is now illustrated in greater detail by way of the following detailed description, which represents the best presently known mode of carrying out the invention. However, it should be understood that this description is not to be used to limit the present invention, but rather, is provided for the purpose of illustrating the general features of the invention.

The term “prime label” as used herein refers to a label or other identification piece that may be used interchangeably with labels, such as tags, typically having a pattern of adhesive disposed on one side of a substrate and one or more graphical illustrations or depictions on the opposite side. Some level of textual messaging may also be provided on the face of the label. The adhesive is typically a pressure sensitive adhesive but may also include activatable adhesives such as thermally or moisture sensitive materials. However, it should be understood that all prime labels need not be provided with an adhesive.

Prime labels are further distinguished from other labels in the art in that such labels are known as having a high level of quality or value. The term prime label is often used to describe a type of label that is the highest grade marketed in a particular industry. Prime labels find application in a number of exemplary areas but have found wide range acceptance particularly in the area of consumer packaged goods (“CPG”) and other products for which the prime label is an effective means for communicating a specific message or enhancing the image of the manufacturer or distributor or presenting the product as a high quality item. Prime labels are also used for business communications in that they can convey certain desirable criteria, image, brand recognition or information and can be used independently of a product, such as in connection with advertising a service opportunity or offering, or with other activities or undertakings, such as for example non-profit organizations.

Prime labels, particularly prime labels prepared in accordance with the present invention, may also contain printed messages, including personalized and/or variable information in addition to the graphical displays. The printed messages can be fixed or static, as will be explained herein, may be personalized or sequentially numbered or provided with other unique or special identifiers.

The term “patterns” as used herein refers to strips, lines, shapes, spots, dots, elements and discontinuous segments, as well as regular and irregular placement of such items. Patterns may also refer to combinations of the above-mentioned items such that one pattern may be a continuous strip; another, segmented elements; and a still further an irregular placement of elements or the like. Any combination of patterns is possible depending on the need or application of the manufacturer or the end user. In addition, the pattern can be prepared in order to accommodate a particular theme, season, event, trade dress, graphics, alpha and numeric characters, and the like. Patterns are used in connection with the present invention to describe the placement of the label segments or ribbons applied to the web or individual prime labels positioned on the web in a particular pattern or arrangement. Pattern as defined herein also is used in connection with the adhesive that is applied to the continuous web.

As used herein the term “business communication piece or document” is used to refer to a substrate that, either alone or in combination with other documents can convey a particular message, image or provide information about a particular product or service that is available from the provider of such pieces or documents. Business communication documents or pieces can include advertising, sales and marketing collateral and such other items used to convey information on written or imaged form sheets, brochures, presentation folders, informational sheets and combinations thereof.

The term “personalized information” refers to information that is printed or imaged onto a substrate which is generally variable or unique and which may change from document to document or segment to segment so as to create a customized message or communication for each recipient. Examples of personalized information may include for example names, addresses, descriptions, plans, coding, numbering, promotional text, etc. that may have been acquired from the intended recipient through surveys, questionnaires or answers given to various inquiries generated in response to a request for goods or services.

The term “static or fixed” information refers to printed or imaged information that generally does not change from document to document or segment to segment and may include a general description or body of information about particular products, services, places, etc. that may be of interest to the intended recipient and represents a standard message that the manufacturing or supplier wishes to convey to an end user or customer of the offering.

The term “intermediate” as used herein refers to a product that undergoes one or more processing steps prior to the intermediate reaching a final condition, that of being ready for end use or application. The additional processing steps may include printing, imaging, folding, sealing, separating, cutting, perforating, scoring, adhering and the like. Typically, a product such as with the present invention is provided in an intermediate condition so that a user can add or manipulate the intermediate to create the final or desired end product, such as applying the prime label to a container, carton or the like. Thus, in accordance with the present invention, the intermediate segment for example, could be subject to die cutting, additional printing, such as through ink jetting, over laminating, coating, embossment, and then applied to a container, carton, consumer package good or the like.

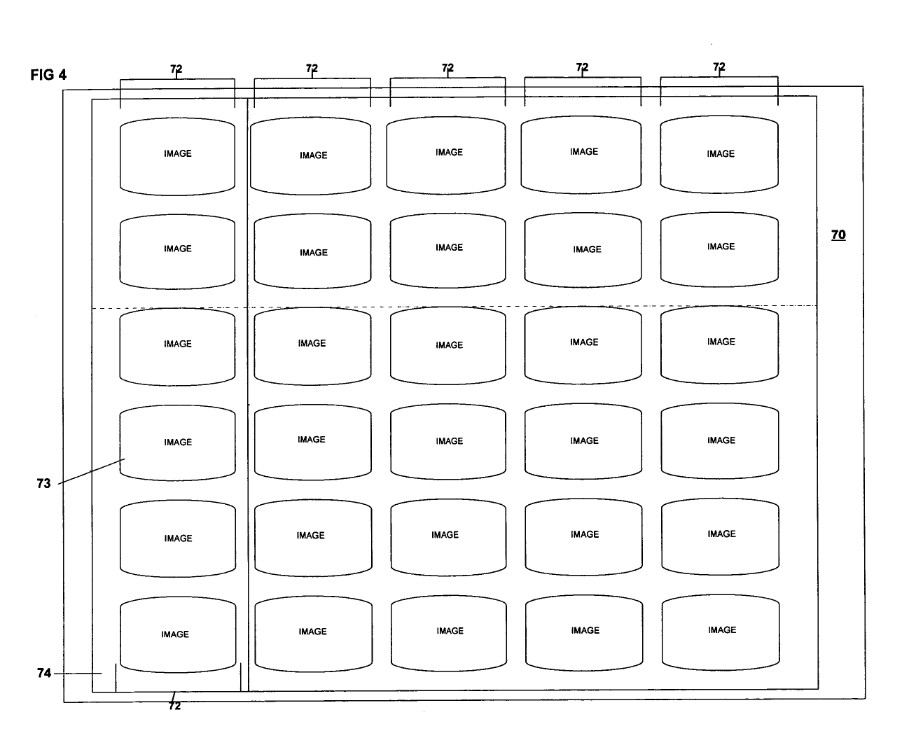

The term “sheets” or “segments” as used herein refers to sheets, segments, ribbons, strips, pieces, parts, sections, subdivisions and combinations thereof. The sheet or segment provided in this specification can be an entire sheet such as 8½″×11″, 11″×14″, 19″×25″ and other known sheet sizes or may be segments, divisions, strips, etc. of such sheets. For example, a 19″×25″, as shown in FIG. 4 and as will be later described herein, the sheet may produced with five rows of labels, with each row having six labels, with each label having dimensions of approximately 3″×4″. In this example, each row for instance may comprise an individual segment or sheet that may be used in practicing the present invention. It should however be understood that the invention is not to be so limited to the foregoing configuration and that individual pieces or elements may be used in connection with this process to produce the intermediate assembly provided herein.

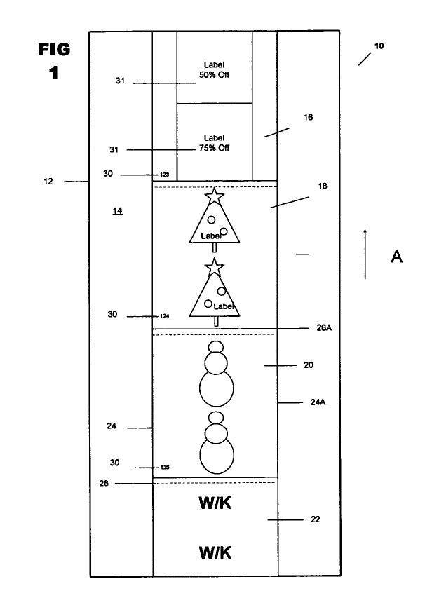

Turning now to drawings of the present invention and initially to FIG. 1. The pressure sensitive prime label intermediate web assembly is generally depicted by reference to the numeral 10. The intermediate assembly 10 includes a carrier web or continuous web 12 that has a first face 14 and a second face (not shown). The second face would be the underside of the carrier web. The continuous web 12 is preferably selected from a highly calendared, cellulosic based stock having a release coating, such as silicone. The release coating is provided on the first face 14 such that when an adhesive is applied, as will be described herein, the adhesive will transfer to the back of the label segments or sheets when the individual prime label intermediates are removed from the web. This will occur as the adhesive has a greater affinity for the label segments or sheets than for the carrier web as the label segments do not have a release coating applied to the surface in contact with the adhesive.

The web assembly 10 is advanced in a machine direction, which is designated as “A”. Machine direction for the purposes of this invention is generally intended to mean the direction in which the apparatus handles the web of material and subsequently advances the web to and through each station resident on the equipment that is used to practice the invention.

As provided in FIG. 1, the web assembly is provided with a number of prime label sheets or segments, 16, 18, 20 and 22. Each label segment has first and second sides and a first and second ends. An individual label segment is identified by reference to segment 20, in which the longitudinally extending sides are designated by 24 and 24A and the first and second ends 26 and 26A. As provided in the drawing, edge 26 is shown in phantom as it is disposed beneath the edge of label segment 22. The label segments may be placed in a substantial edge to edge configuration, which may preferably result in a slight overlap of successive label segments. Thus, edge 26 is disposed beneath the edge of the successively applied direction (again referring to the machine direction “A”). It should be understood, that while an overlap may be created, the successive label segments need not overlap one another or alternatively, the label segments may be spaced from one another.

By creating a slight overlap as described above and depicted in FIG. 1, the intermediate web assembly 10 is provided in an intermittent laminated configuration, that is, not all portions of the label segments are in full adhesive contact or fully adhered to the web 10. That is, a portion of the label segments are free of attachment to the web as well as successive label segments, that is, they are not connected to one another.

FIG. 1 is also used to show that the prime label segments 16, 18, 20 and 22 each contain different indicia images and geometric configurations. In addition to generally quadrate shapes depicted in label segment 16, label segment 18 is provided with inanimate shapes, label segment 20 with another geometric pattern that is non-quadrate and label segment 22 is provided with alpha characters “WK.” Thus, each label segment may be provided with different indicia or shapes or alternatively, it should be understood that the invention can be practiced such that each label segment may be provided with identical graphical depictions.

The unique process described in the present invention also permits the label segments 16, 18, 20, etc. to be provided with sequential numbering 30 or other indicia such as variable indicia 31 which shows a possible coupon application for CPG's. This may be accomplished in one of two fashions. In a first arrangement, the label segments are individual sheets and are prepared prior to being applied to the continuous web or carrier as will be described herein. Thus each sheet, before being provided for inclusion in the process may be printed with the variable information such as with an Indigo 3050 available from HP of Palo Alto, Calif. In the second arrangement, the sheet may be imaged after it has been applied to the web such as with an ink jet printer available from Scitex of Dayton, Ohio with such imaging to include the personalization or application of variable data in line.

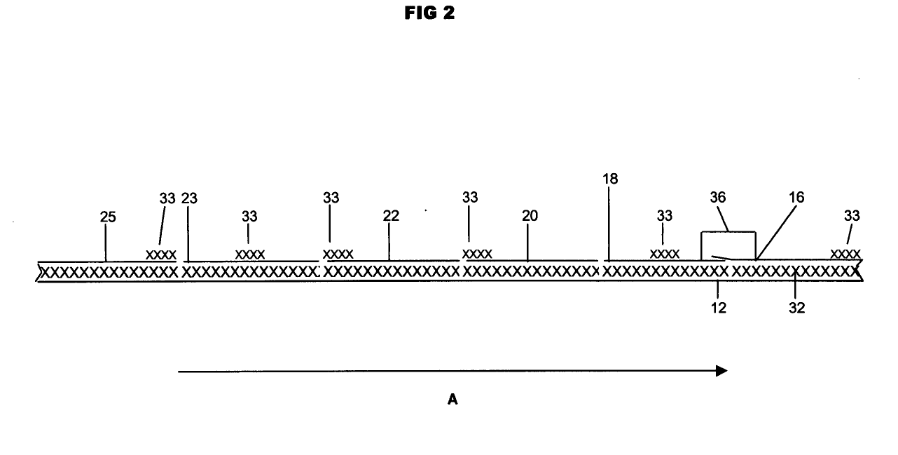

FIG. 2 provides a side elevation of the label web intermediate shown in FIG. 1. The machine direction is again referenced by the character “A”. Carrier or continuous web 12 is coated with a pattern of adhesive 32, preferably a permanent pressure sensitive adhesive, which is depicted through a series of “xxxxx”. The pattern of adhesive may be applied in a continuous format, intermittently, in a particular sequence such as lines, segments, or in any other manner which may be required to accommodate the final arrangement or configuration of the prime labels. It should, however, be understood that the adhesive may be a removable or a repositionable adhesive or be an activatable adhesive such as those that are thermally or moisture sensitive. The pattern of adhesive will have a thickness ranging from between about 0.03 mils to 3 mils, more preferably between about 0.04 mils to 1.5 mils and still more preferably between about 0.07 mils to 1.0 mils.

The adhesive 32 is provided on the first face of the carrier web 12 and due to a release coating, as described above, the adhesive will release to, or remain with the label segments when the segments are peeled off or pulled away from the carrier web. The adhesive pattern 32 preferably may be only as wide as the portion of the label segment or ribbon that is applied to the web 12 from which will ultimately form the prime label after die cutting and/or removal. That is, the label segment or ribbon will cover the pattern of adhesive. The adhesive pattern may also be applied in such a way that the area of the adhesive will only preferably cover about the approximate area occupied by the prime label that is to be die cut from the segment. That is, the label ribbon or segment will be larger, typically wider, than the pattern of adhesive. It is preferred, however, that there is no exposed adhesive so that the web does not inadvertently cling to another portion of the apparatus which may cause jamming, or other areas or portions of the web when the web is wound onto itself which may cause successive layers in the roll to cling or adhere together.

The label segments shown in FIGS. 2, 16, 18, 20, 22, 23 and 25 each have graphical depictions 33 provided on the upper surface or face. Preferably, the graphics provided on the face will have a resolution of greater than about 150 lines per inch, more preferably greater than about 200 lines per inch, and still more preferably in the range of about 300 lines per inch or in the range of approximately 2500 to 3500 dots per inch. In addition to graphical representations, raised areas, such as pseudo embossments may be created such as described in commonly assigned, co-pending application Ser. No. 10/980,347 filed Nov. 3, 2004 the disclosure of which including that found in the claims is incorporated herein by reference.

FIG. 2 also provides a further depiction of an exemplary area of overlap between successive label segments as designated by reference to numeral 36. As is seen in the FIGURE, the labels may be arranged end to end, have an overlap or combination thereof.

The area of overlap is less than one inch, more preferably less than one half of one inch and still more preferably about ⅛ of an inch and yet still more preferably less than about 1/32 of an inch to about 1/64 of an inch. The area of the overlap provides a border, margin or matrix for each label that surrounds the area that will become the prime label. The area of the matrix or margin ranges between about ¼″ to about ⅛″ and more preferably about 1/32″ to about 1/64″ to compensate for the possible overlap between successive label segments or sheets. That is, no area of the prime label intermediate will encroach on another label segment and the overlap, if present, is only represented by the area of the margin or matrix. While the invention has been described in the present embodiment as having an area of overlap, it should be understood that the invention might be practiced where the edges of successive labels substantially abut one another or alternatively, there may be a slight space or gap between successive labels.

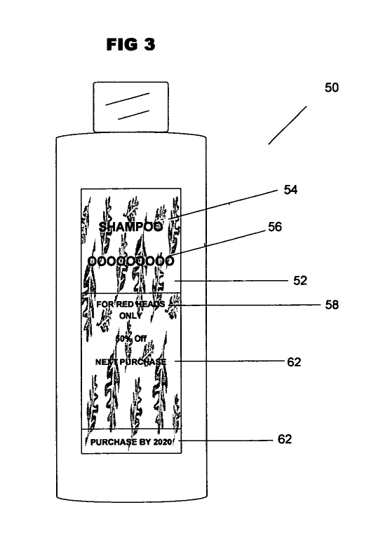

FIG. 3 demonstrates an exemplary use of a prime label prepared in accordance with the present invention. A consumer package group, such as a package 50, in this example a bottle, is shown having a prime label 52 applied to an exposed surface. The pacakge as used in the present invention may be a bottle, box, carton, jug, jar, package or any other container or receptacle that may be used, for example, for a CPG or it may be used in connection with shipping packages, parcels, envelopes and the like.

The prime label 52 is provided with a number of fields which include static or fixed indicia, such as the word “shampoo” shown by reference numeral 54, graphical depictions referenced by numerals 56 such as leaves or foliage, personalized indicia 58 carrying the phrase “For Redheads Only”, variable indicia at 60 and 62 such as coupon indicia and “purchase by” information. The ability to print the prime label with all pertinent graphics and indicia prior to application to the container or package will facilitate the processing of the labeling application and thus eliminate the need to have additional offline equipment to add such information.

FIG. 4 is used to illustrate a sheet of stock material 70, which is provided with a series of label segments or ribbons 72, which are prepared prior to use in the present process. The stock material 70 may be any suitable material such as a cellulosic based stock or it may consist of synthetic films, e.g. plastics, films, foils and the like. The base stock 70 is provided in one of any standard sheet formats that may be used by a high resolution imaging device such as Indigo®, available from Hewlett Packard of Palo Alto, Calif. or Karat available from KBA of Williston, Vt. In the present drawing, the standard sheet size shown is approximately 19″×25″ and shows a number of label segments each represented by numerical reference 72 and each consisting of six labels, represented by reference numeral 73. Each of the labels in this example have a dimension of approximately 2.875″×4″. It should be understood that any standard label size might be produced as well as odd sized labels or labels having different configurations or shapes. The stock 70 is then cut or severed to produce individual segments 72 or strips, with each segment having a margin 74. The margin or matrix is used to accommodate any area of overlap (ranging from about ½ of an inch to about 1/64 of an inch) that may occur when placing the label successive segments on a web as will be described later herein. In addition, the margin 74 is part of the overall matrix (extra material surrounding each label) that will be removed after the step of die cutting to allow individual labels to be provided on the web.

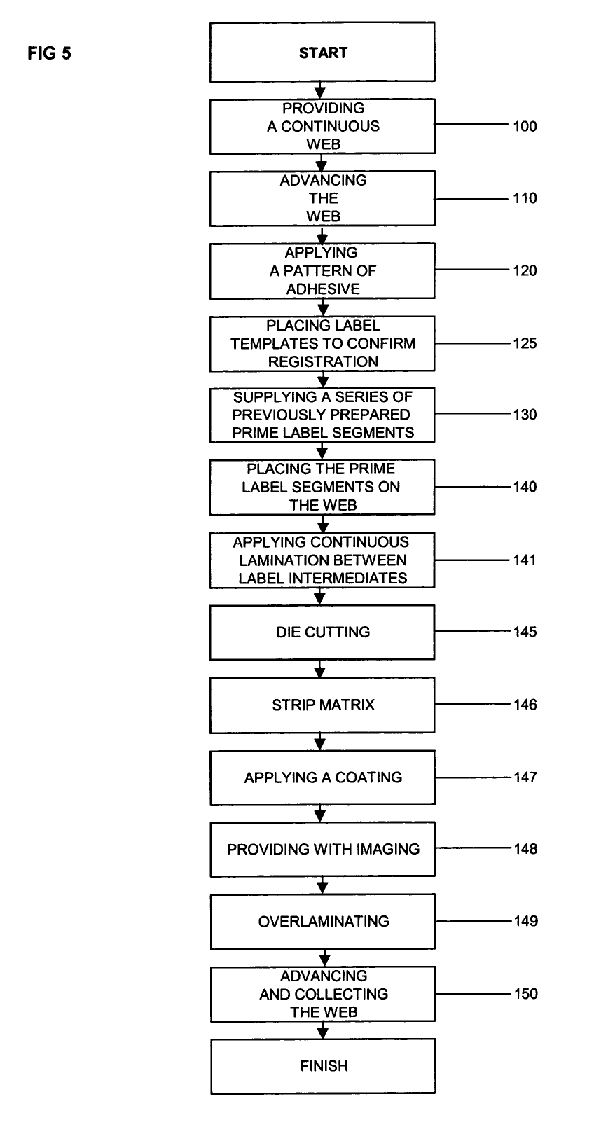

Reference is now directed to FIG. 5 in which a block diagram is provided to illustrate the steps that are utilized in carrying out the present invention. The process begins by providing a continuous web or carrier web at step 100. The carrier web as described above will have a release coating provided on the face or surface that will receive the pattern of adhesive in a subsequent step. Next, the web is advanced in a machine direction at step 110. A pattern of adhesive is applied at step 120 and the application of the adhesive is performed through the use of conventional adhesive applications devices, such as slot die applicators or other suitable equipment such as screen coater, etc. The adhesive is generally applied only in those areas where a label segment, strip or sheet will be positioned so as to avoid having adhesive exposed on the web which may hinder downstream processing of the pressure sensitive laminate web assembly. It should be appreciated however, that if adhesive is applied to the web and remains exposed after placement of the label strip or segment, that the exposed adhesive can be treated to “deaden” the adhesive so that it is no longer tacky.

In practicing the invention shown in FIG. 5, it may be desirable to first apply or position one or more label templates at step 125. The label templates will have the general size and shape of the label segments or sheets that may be subsequently positioned on the web, but typically will not carry a final image or graphics that will be used in the preparation of the label intermediate web assembly. It should, however, be understood that use of the label templates is not necessary and the process may simply begin with the placing of label segments or sheets that carry the final design or indicia that is to be produced in the present job or order.

Continuing with the discussion of the process depicted by the block diagram in FIG. 5, a series of prime label segments, ribbons or sheets is supplied to a placing mechanism, which is subsequently described in reference to a later drawing, at step 130. The label segments will preferably be of a uniform size and shape so that the placing mechanism may readily place the segments on the web, however, different sized and shaped segments and odd shaped segments (geometric, animate, inanimate shapes) may also be provided and placed on the web using the process of this invention. For example, the label segments may include quadrate, animate or inanimate shapes that are placed in the placer mechanism in an order that they are intended to appear, e.g. quadrate, animate, inanimate and then repeating. In this way, customized label webs can be created and tailored to the individual needs of the end user.

The label segments are placed individually on the continuous web at step 140. Preferably, the placement of the label segments will permit a slight overlap of the segments on one another, so that a label web having an intermittent lamination is created. That is, the label segments when appearing in this overlapping arrangement will not be fully adhered or attached to the web. It should, however, be understood that no overlap may occur and the label segments may substantially abut one another or there may be a space between the segments or a combination of the foregoing may occur. That is, there may be some label segments that overlap, some segments that abut one another and some segments that are spaced from one another. In practicing the invention, the area occupied by the portion of the label segment that will become prime label intermediate will preferably be fully adhered to the web.

Optionally, the prime label intermediates may be connected to one another through use of a tape or string which may be applied at step 141 so that when the matrix is stripped away during a later processing step, the labels remain adhered to the web and are not inadvertently separated by the matrix removal. Where such tapes or strings are used, the tape or string would then be snapped or broken when the label is removed from the web prior to application to the article or package. Alternatively, the string may come off with the matrix.

Once the prime label segments are placed on the web, the web may be advanced to a die cutting station at step 145 where a cut will be made so that the prime label may be removed from any matrix or extra material when the prime label is ready to be applied to a container. It should be understood that the string that has been applied to the intermediates or segments may also be peeled away with the matrix.

Down stream from step 140, the placing of the individual label segments on the web several optional operations may be performed. These include steps 146 the stripping off of the matrix, 147 application of a coating, 148 providing additional variable or personalized imaging and 149 over laminating. Any combinations of these steps may be practiced or all of them may be used in producing a particular job or order.

As described previously, step 146 relates to the stripping of the matrix. The die cutting operation performed at 145 creates a cut between the area to be utilized as a prime label and the surrounding material that was provided with the label segment or strip.

Step 147 provides for the application of a particular coating such as a varnish so that the prime label will appear to have a glossy finish, a curable coating so that pseudo embossments may be created or other coatings to treatments that may be desirable in creating a particular configuration of a product.

As mentioned previously, one of the many potential benefits of the present invention is the ability to add additional variable or personalized printing or imaging in line and this is accomplished at step 148. Through use of this step, the manufacturer can provide additional text, graphics and other indicia to help highlight particular features of the product or service to which the prime label has been applied.

The final optional step mentioned above includes over laminating which is performed at step 149. In this step, plastic films can be applied over the top of the web so that cards having prime label type graphics can be produced by laminating a plastic film to the web. It should be appreciated that the films may be applied either to the top, bottom or both.

The pressure sensitive prime label intermediate web assembly after processing through the above-mentioned steps and potentially one or more optional steps is collected at step 150. This step may include the winding of the web into a roll so that the web of labels can be taken to an application site where individual labels may be removed from the web, such as by an automatic applicator and then applied to packages or containers.

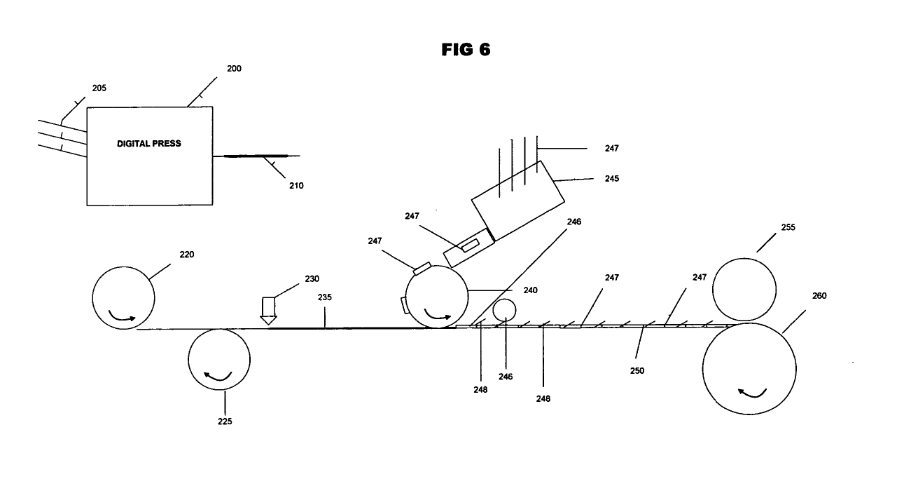

FIG. 6 provides a schematic representation of the apparatus used to carry out the present invention. Reference numeral 200 depicts a digital, sheet fed press such as Indigo® available from Hewlett Packard Company of Palo Alto, Calif. or Karat available from KBA of Williston, Vt. The press is provided with blank sheet stock 205 and then produces an image on the stock 210, depicted by a darkened area in the drawings which is then cut into individual label segments as described above. The individual segments are then loaded into a placer or insertion device such as a Maverick® available from InLine Automation of Minneapolis, Minn. as will be described herein.

The schematic of FIG. 6 shows a continuous carrier web depicted by reference numeral 220 which is supplied from a roll and is advanced to a coating area in a machine direction “A” by machine means such as rollers, belts and the like represented by numeral 225. The web 220 and is passed beneath an adhesive coating station 230 such as a slot coater, screen coater or other suitable means that can apply a pattern of adhesive to the web. The pattern of adhesive will generally only be the width of the label segments that are to be applied to the web.

The adhesive coated web 235 is then passed to a cylinder 240, e.g. vacuum, which is mounted beneath an insertion unit 245. Each of the pre-printed label segments 247 is passed by the inserter to the cylinder 240 and rotates around with the cylinder until it is placed on the adhesive coated web 235. The sheets 247 are placed serially and sequentially on the web so that the indicia and graphics are preferably visible. It should be understood that the graphics side may be placed face down so that they would be visible through a container, such as a glass bottle when the label was applied or alternatively, graphics may be applied on both faces of the label. As previously described, the label segments may preferably be placed in a slight overlapping relationship, slightly abutting or spaced from one another or a combination of the foregoing.

The label segments 247 may be temporarily joined to one another by tape strips or strings represented by numeral 248 so that when the matrix is stripped away, the tape strips will aid in holding the prime label intermediates in position and the prime labels will not be removed. The tape strips 248 are supplied from a roll 246 or other suitable application means. Alternatively, the strip or string may come off with the matrix.

Once the label segments have been placed on the web, the web may be advanced through additional stations, such as die cutting, 255 or coating, printing, over laminating, etc. and once the processing is completed, the intermediate web 250 is then collected such as by rewinding 260.

The label roll may then be removed to a use or application location where the individual prime labels are removed from the web and placed on containers or packages such as by a high speed label applicator.

The press speed runs at least at approximately about 50 feet per minute, more preferably between about 75 and 150 feet per minute and still more preferably at around about 200 feet per minute.

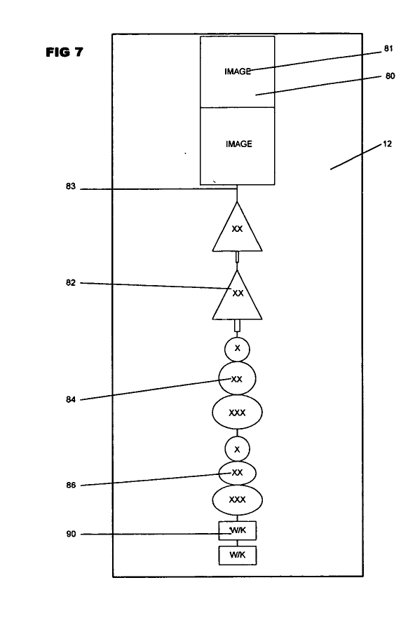

Turning now to FIG. 7 of the present invention, the carrier web 12 is shown with a number of prime labels which have had the matrix removed from around the area of the segment that is to make up the prime label. A series of prime label intermediates is shown which provides the variety of uses that can be made through use of the present invention. Prime label intermediate 80 is a substantially quadrate section having variable indicia 81 applied, intermediate 82 is a triangular prime label intermediate and label intermediate 82 and 81 are shown connected to one another through use of a tape or string referenced by numeral 83. It should be appreciated that the tape or string 83 may not be necessary and may only be applied to aid in holding the label segments together while the web is being collected. The tape segments will break easily so as to not detract from the label when placed on the container or receptacle.

A variety of other prime label intermediates are also shown on the web, including 84 and 86 shown as “snowmen” and 90 quadrate labels. Each of the labels are shown connected to one another through the use of tape strips or strings 83. While the FIGURE provides a variety of different label configurations, it will be understood that these label configuration can be created either through use of various die cuts or more preferably, but inserting into the placer mechanism label segments or ribbons having different configurations. In addition, the prime label intermediates may be inserted into the placer mechanism in a previously die cut arrangement.

Through use of the present invention, a vast array of identifiers, e.g. labels, tags, cards, plates, etc. can be placed on an adhesive coated web and then collected for later use, thereby creating a versatile pressure sensitive intermediate web assembly. Through the use of the foregoing process a manufacturer may create innumerable high quality graphics, illustrations and variable and personalized text and indicia to create a greater impact on the potential consumer or end user. The foregoing process has a number of benefits over conventional technologies in that the process can occur at roughly equivalent press speeds and may be handled by conventional label applicators.

The present invention further fulfills the need of the small to medium range market for prime labels, those quantities typically between 100 and 1,000,000 without requiring the payment of substantial premiums as may be necessary to offset the costs associated with traditional processes such as flexographic technology.

It will thus be seen according to the present invention a highly advantageous prime label assembly and method of manufacturing has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A pressure sensitive prime label intermediate web, comprising;
a continuous base web having first and second faces and first and second longitudinally extending sides and a release coating applied to a portion of said first face;
a pattern of adhesive is applied over said release coating on said first face of said continuous base web, between said first and second longitudinally extending sides and in a machine direction;
a series of individual pre-imaged sheets having first and second faces, first and second ends and first and second sides, at least said first face of each of said sheets having at least graphical depictions with each depiction having a high quality image resolution, each of said sheets is divided into individual label segments with each segment containing at least one graphical depiction; and
said second face of each of said segments is placed in contact with said pattern of adhesive such that said segments are intermittently adhered to said first face of said continuous base web in a pattern such that, said segments with imaging are disposed substantially in an end to end configuration and said segments are themselves not connected to one another to create an intermediate prime label web assembly having a series of discontinuous prime label segments with individual prime label intermediates that are substantially free of connection to one another.

2. A pressure sensitive prime label intermediate web as recited in claim 1, wherein said sheets are provided with sequential numbers.

3. A pressure sensitive prime label intermediate web as recited in claim 1, wherein said segments are provided with personalized or variable information in addition to said graphical depiction.

4. A pressure sensitive prime label intermediate web as recited in claim 1, wherein said segments overlap one another a distance of less than one inch and preferably less than one half of one inch to create an intermittently laminated pressure sensitive web assembly.

5. A pressure sensitive prime label intermediate web as recited in claim 4, wherein said graphical depiction for each label segment is distinct from graphical distinctions in successive segments.

6. A pressure sensitive prime label intermediate web as recited in claim 1, wherein said segments have a shape that is non-quadrate.

7. A pressure sensitive prime label intermediate web as recited in claim 6, wherein said shape of said segments may be selected from a group of configurations including non-quadrate geometric, animate, inanimate, alpha and numeric shapes.

8. A pressure sensitive prime label intermediate web as recited in claim 1, wherein said segments are provided with embossments.

9. A pressure sensitive prime label intermediate web as recited in claim 1, wherein each of said segments include at least one distinct label segment having a resolution of greater than about 150 lines per inch.

10. A pressure sensitive prime label intermediate web as recited in claim 1, wherein each of said sheets include at least two distinct label segments each having a resolution of greater than about 200 lines per inch and preferably more than about 250 lines per inch.

11. A prime label intermediate web assembly, comprising,
a continuous carrier web having first and second faces, first and second longitudinally extending sides and a release coating applied between said first and second longitudinally extending sides and on said first face;
an adhesive applied to said carrier web and over said release coating;
a sheet of material having a number of pre-printed prime label areas divided in to individual segments with each of said segments having a dimension less than said sheet and each segment having at least one prime label area, with each of said prime label areas having a graphical depiction provided on at least one face; and
wherein each of said segments is applied in a pattern to said carrier web over said adhesive substantially in an edge to edge configuration such that said first face with said graphical depiction is visible upon application to a container.

12. A prime label intermediate web assembly as recited in claim 11, wherein each of said prime label areas is provided with identical graphical depictions.

13. A prime label intermediate web assembly as recited in claim 11, wherein each of said prime label areas has graphical depictions that are distinct from successively placed segments.

14. A prime label intermediate web assembly as recited in claim 11, wherein each of said segments containing said prime label areas is provided in a previously die cut configuration selected from a group including geometric, animate, inanimate and combinations thereof.

15. A prime label intermediate web assembly as recited in claim 1 1, wherein each of said segments includes a strippable matrix.

16. A prime label intermediate web assembly as recited in claim 11, wherein each of said prime label areas from said segments or matrix of said segments are connected one to one another through a tape strip or string.

17. A prime label intermediate web assembly as recited in claim 1 1, wherein each of said prime label areas is provided with personalized or variable indicia in addition to said graphical depictions.

18. A pressure sensitive prime label intermediate assembly for use in package labeling, comprising;
a package having at least one surface suitable for receiving a label;
a prime label applied to said package on said at least one surface, said prime label is produced from an intermediate web assembly comprising a continuous carrier web having first and second faces and first and second longitudinally extending sides;
said intermediate web assembly including a pattern of adhesive applied to said first face of said continuous carrier web and between said first and second longitudinally extending sides; and
said intermediate web assembly further including a series of individual pre-imaged prime label segments having first and second faces, first and second ends and first and second sides, said first face of each of said prime label segments having at least identical graphical depictions, said second face of each of said segments is placed in a pattern in contact with said pattern of adhesive such that said segments are adhered to said first face of said continuous carrier web, said pre-imaged segments are disposed in an end to end configuration and are not connected to one another to create an intermediate prime label web assembly having a series of discontinuous prime label segments.

19. A pressure sensitive prime label intermediate assembly for use in package labeling as recited in claim 18, wherein said prime label has a resolution of at least 200 lines per inch and a shape that may be selected from a group of configurations including geometric, animate, inanimate, alpha and numeric shapes.

20. A pressure sensitive prime label intermediate assembly for use in package labeling as recited in claim 18, wherein said prime label is provided with variable or personalized indicia prior to being applied to said package.
